(19) United States
(12) Patent Application Publication
(10) Pub. No.: US 2009/0225044 A1
(43) Pub. Date: Sep. 10, 2009

(54) DETERMINING TOUCH ON KEYS OF TOUCH SENSITIVE INPUT DEVICE

(75) Inventors: Yung Jin Jeon, Uiwang-si (KR); Dong Hyun Shin, Seoul (KR); Yeon-Sook Park, Seoul (KR)

Correspondence Address: FENWICK & WEST LLP, SILICON VALLEY CENTER, 801 CALIFORNIA STREET, MOUNTAIN VIEW, CA, 94041, US

(73) Assignee: Leadis Technology, Inc., Sunnyvale, CA (US)

(21) Appl. No.: 12/043,426

(22) Filed: Mar. 6, 2008

(51) Int. Cl. G06F 3/041

(52) U.S. Cl. 345/173

(57) ABSTRACT

A key is determined to be the user-selected key of a touch sensitive input device if the touch on the key is determined to be valid continuously for longer than a first predetermined period of time. Another key may be determined to the user-selected key, replacing the previously determined user-selected key, if the touch on another key is valid continuously for a second predetermined period of time that may be longer than the first predetermined period of time.

### BACKGROUND OF THE INVENTION

1. Field of the Invention

The present invention relates to a touch sensitive input device and more specifically, to a method and apparatus for determining user's touch on keys of a touch sensitive input device.

2. Description of the Related Arts

Modern electronic devices often have touch sensors to receive input data. There are a variety of types of touch sensor applications, such as touch screens, touch buttons, touch switches, touch scroll bars, and the like. Touch sensors have a variety of types, such as resistive type, capacitive type, and electromagnetic type. A capacitive touch screen is coated with a material, typically indium tin oxide, that conducts continuous electrical current across a sensor. The sensor exhibits a precisely controlled field of stored electrons in both the horizontal and vertical axes of a display to achieve capacitance. The human body is also an electrical device which has stored electrons and therefore also exhibits capacitance. When the sensor's normal capacitance field (its reference state) is altered by another capacitance field, e.g., by the touch with someone's finger, capacitive type touch sensors measure the resultant distortion in the characteristics of the reference field and send the information about the touch event to the touch screen controller for mathematical processing. There are a variety of types of capacitive touch sensors, including Sigma-Delta modulators (also known as capacitance-to-digital converters (CDCs)), charge transfer type capacitive touch sensors, and relaxation oscillator type capacitive touch sensors.

FIG. 1 illustrates a conventional touch sensitive keypad. The touch sensitive keypad 100 includes a plurality of keys 102, 104, 106, . . . , 124 each corresponding to numbers 1, 2, 3, . . . , 9, *, 0, and #. Such conventional touch sensitive keypad 100 is commonly used, for example, in telephones such as cellular telephones, smartphones, and the like, to receive input from users. For example, a cellular telephone user may dial a telephone number to call using such touch sensitive keypad. When capacitive type touch sensors are used, each of the touch sensitive keypads (102, 104, . . . , 124) are associated with a corresponding touch sense capacitor (not shown in FIG. 1) that senses user's touch on the associated key by detecting a change in capacitance on the touch sense capacitor that may be caused by the user's touch. However, when the keypads (102, 104, . . . , 124) are densely placed in a small area, capacitive touch sensors suffer ambiguity problems. For example, a user's finger may overlap on both a desired key and adjacent keys, due to large finger sizes or by pressing on the keypad surface hard and thereby deforming his or her finger.

Thus, there is a need for a technique for determining a user's touch on keys of a touch sensitive input device without such ambiguity.

### SUMMARY OF THE INVENTION

Embodiments of the present invention include a method for determining a user's touch on keys of a touch sensitive input device such as a touch sensitive keypad. According to various embodiments of the present invention, a key is determined to be the user-selected key if the touch on the key is valid continuously for longer than a first predetermined period of time. Another key may be determined to be the user-selected key, replacing the previously determined user-selected key, if the touch on said another key is valid continuously for a second predetermined period of time. In one embodiment, the second predetermined period of time may be longer than the first predetermined period of time.

The method of determining a user's touch according to the present invention has the advantage that both the intensity and the length of the user's touch on the touch sensitive keys are considered in determining whether a particular key was touched by a user and whether to change the determined user-selected key. The threshold value for determining a valid touch or the first and second predetermined periods of time may be programmable, and thus the sensitivity of the method according to the present invention may be conveniently modified, providing flexibility to a touch sense controller. By using different first and second predetermined periods of time for determining an initial touch key and a change of the touch key, respectively, the touch sense controller may more accurately detect the user's touch of the keys without necessarily changing the touch key due to accidental touches on another, unintended key. As a result, ambiguities in determining a user's touch on keys of the touch sensitive input device are significantly reduced.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

The teachings of the embodiments of the present invention can be readily understood by considering the following detailed description in conjunction with the accompanying drawings.

FIG. (FIG.) 1 illustrates a conventional touch sensitive keypad.

FIG. 2 illustrates a touch sensor controller circuit for determining a user's touch on keys of a touch sensitive input device, according to one embodiment of the present invention.

FIG. 3A illustrates a method for determining a user's touch on keys of a touch sensitive input device, according to one embodiment of the present invention.

FIG. 3B illustrates an example of how the user's touch on keys of a touch sensitive input device is determined by the method of FIG. 3A, according to one embodiment of the present invention.

FIG. 4A illustrates a capacitance to digital converter (CDC) circuit used with the touch sensor controller circuit of FIG. 2, according to one embodiment of the present invention.

FIG. 4B illustrates the operation of the CDC circuit of FIG. 4A in one phase, according to one embodiment of the present invention.

FIG. 4C illustrates the operation of the CDC circuit of FIG. 4A in another phase, according to one embodiment of the present invention.

FIG. 5A is a timing diagram illustrating the operation of the CDC circuit of FIG. 4A, when the capacitance on the sense capacitor is not disturbed by a touch on the corresponding key.

FIG. 5B is a timing diagram illustrating the operation of the CDC circuit of FIG. 4A, when the capacitance on the sense capacitor is disturbed by a touch on the corresponding key.

### DETAILED DESCRIPTION OF EMBODIMENTS

The Figures (FIG.) and the following description relate to preferred embodiments of the present invention by way of illustration only. It should be noted that from the following discussion, alternative embodiments of the structures and methods disclosed herein will be readily recognized as viable alternatives that may be employed without departing from the principles of the claimed invention.

Reference will now be made in detail to several embodiments of the present invention(s), examples of which are illustrated in the accompanying figures. It is noted that wherever practicable similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles of the invention described herein.

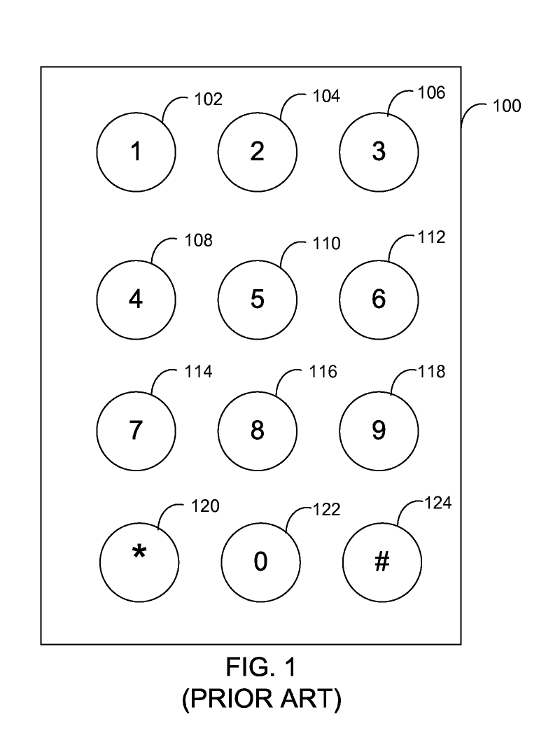

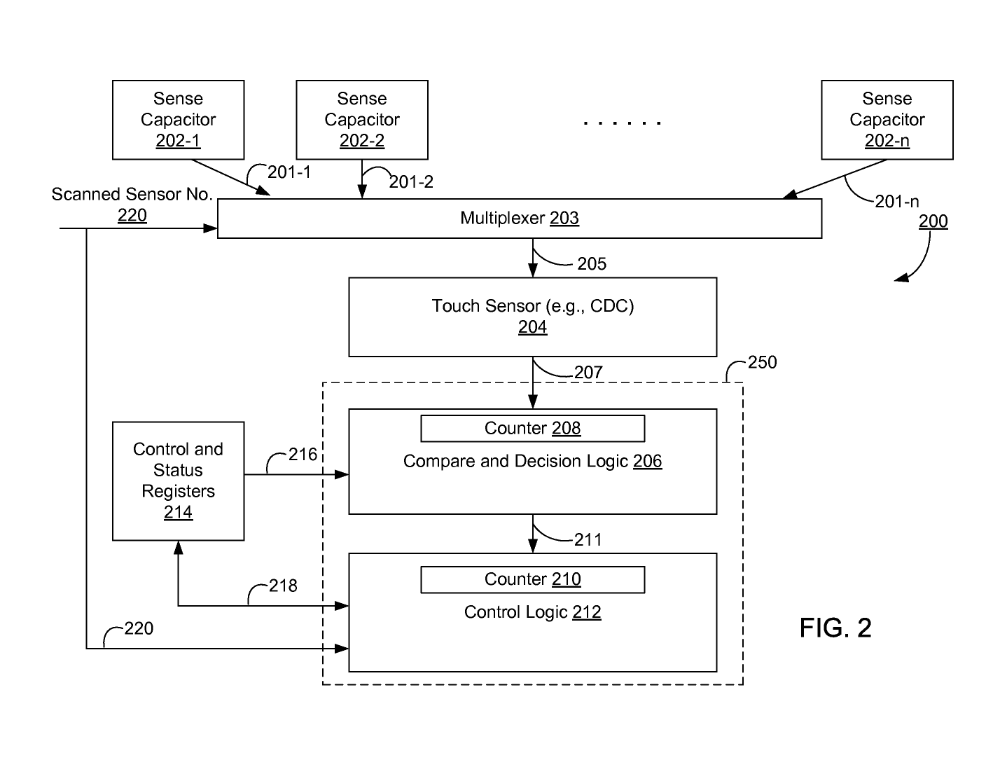

FIG. 2 illustrates a touch sensor controller circuit for determining a user's touch on a touch sensitive input device, according to one embodiment of the present invention. Touch sensor controller circuit 200 includes a plurality of sense capacitors 202-1, 202-2, . . . , 202-n, multiplexer 203, touch sensor (e.g., CDC) 204, touch controller logic 250 (including compare and decision logic 206 and control logic 212), and control and status registers 214. Compare and decision logic 206 includes a counter 208, and control logic 212 also includes a counter 210.

Sense capacitors 202-1, 202-2, . . . , 202-n are capacitors that are used to detect changes in charges or capacitances in the sense capacitors caused by a user's touch on corresponding keys of the touch sensitive input device. In the example of FIG. 2, there are n number of sense capacitors 202-1, 202-2, . . . , 202-n, and each sense capacitor corresponds to at least one corresponding key of the touch sensitive input device. For instance, the example telephone keypad 100 of FIG. 1 has 12 keys and thus may include 12 sense capacitors 202-1, 202-2, . . . , 202-12 each corresponding to one of the keys of the telephone keypad 100. When, a user touches one of the keys 102, 104, . . . , 124 of the touch sensitive keypad 100, that causes a change in the capacitance of one of the sense capacitors 202-1, 202-2, . . . , 201 -n corresponding to the touched keys. However, when the user's touch overlaps more than one key, changes in the capacitance occur in more than one sense capacitor 202-1, 202-2, . . . , 201-n, thereby leading to ambiguity that needs to be resolved.

Multiplexer 203 receives the detected change in capacitance (charges) 201-1, 201-2, . . . , 201-n from sense capacitors 202-1, 202-2, . . . , 202-n, and outputs one of such detected change 205 in capacitance (charges) 201-1, 201-2, . . . , 201-n at a given time under control of the scanned sensor number signal 220 from a system host controller (not shown). In this regard, the touch sense controller circuit 200 is configured to scan the sense capacitors 202-1, 202-2, . . . , 201-n in a sequential manner, one by one, periodically. The time it takes for the touch sense controller circuit 200 to scan all the sense capacitors 202-1, 202-2, . . . , 202-n is referred to herein as “scan period.” One scan period may be, for example, 2 ms. The interval of one scan period may depend on the CDC decimation rate. Scanned sensor number signal 220 indicates which sense capacitor 202-1, 202-2, . . . , 202-n is being scanned by the touch sense controller circuit 200 at any given moment. In one scan period, scanned sensor number signal 220 rotates from sense capacitor 202-1 corresponding to key 1, sense capacitor 202-2 corresponding to key 2, and so forth until it reaches the last sense capacitor 202-n, and then repeats scanning the sense capacitors in the next scan period, and so forth.

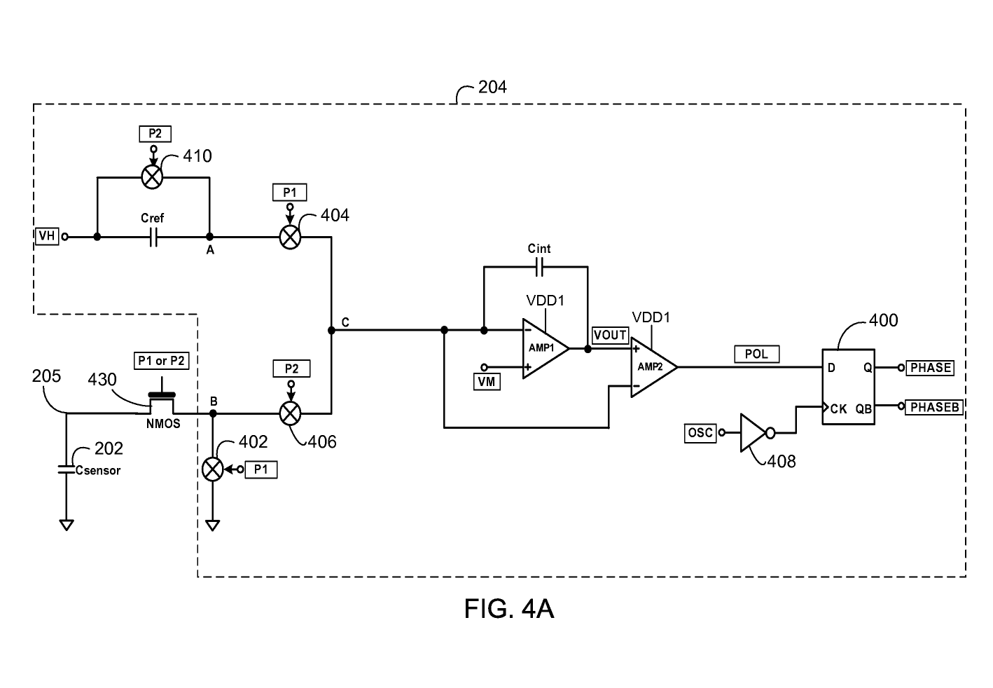

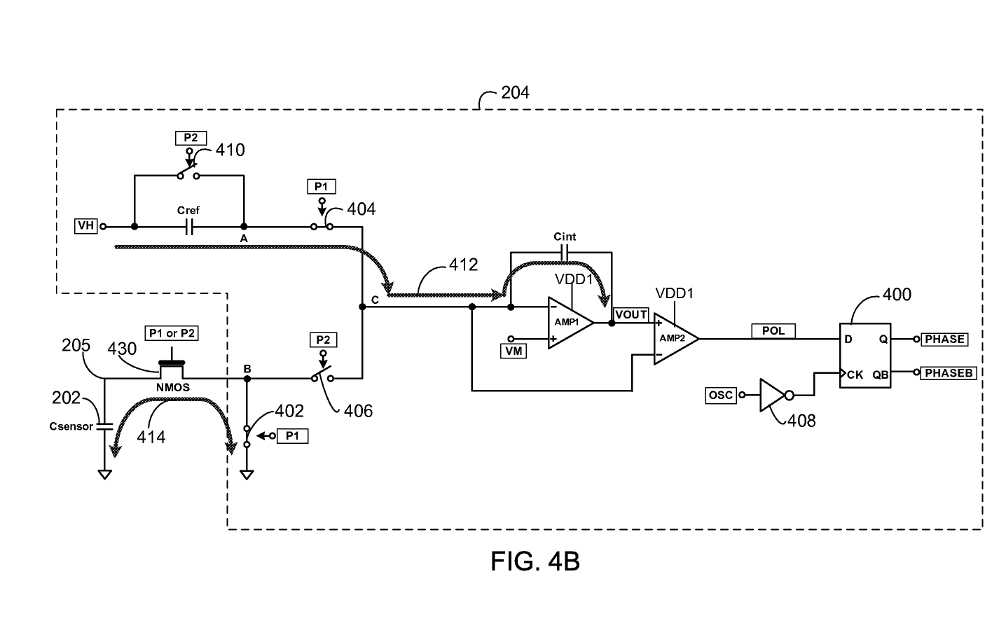

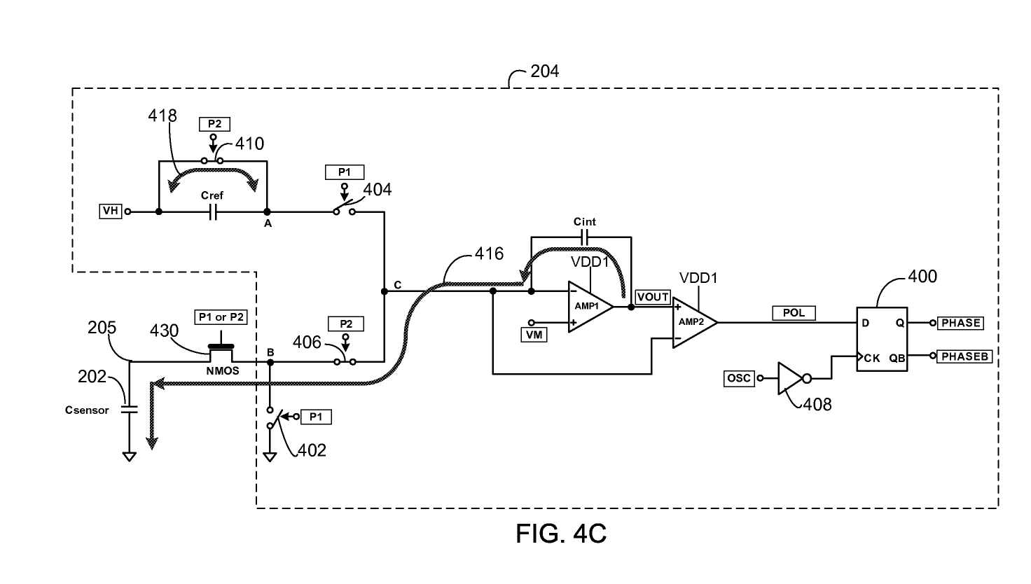

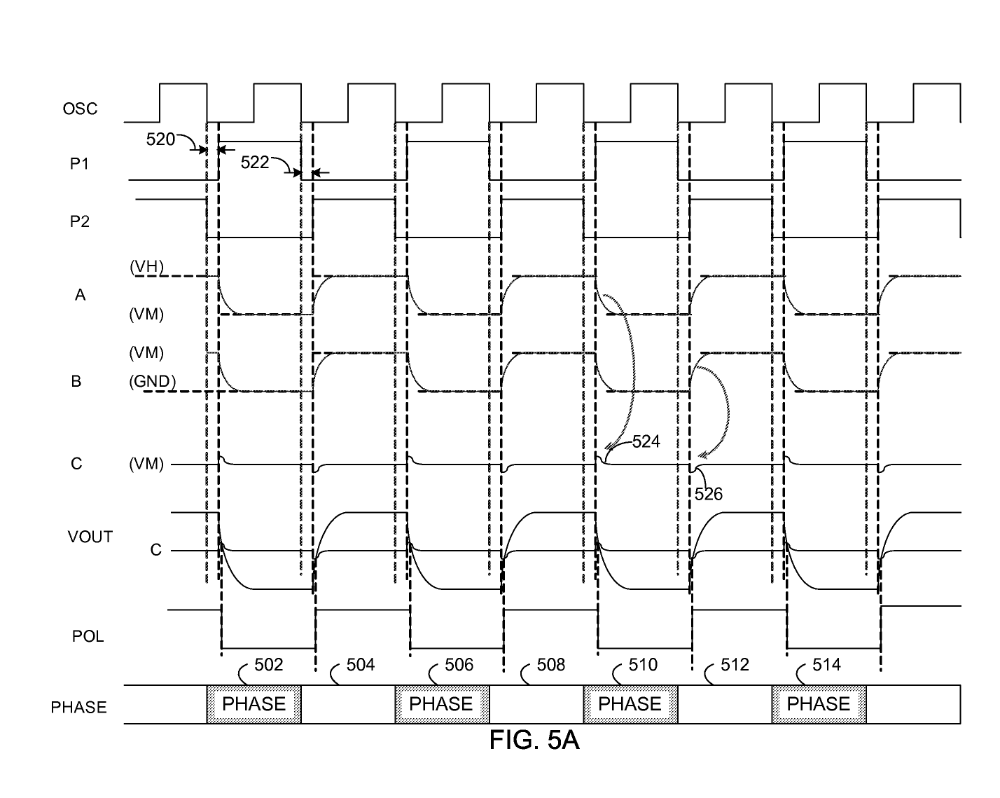

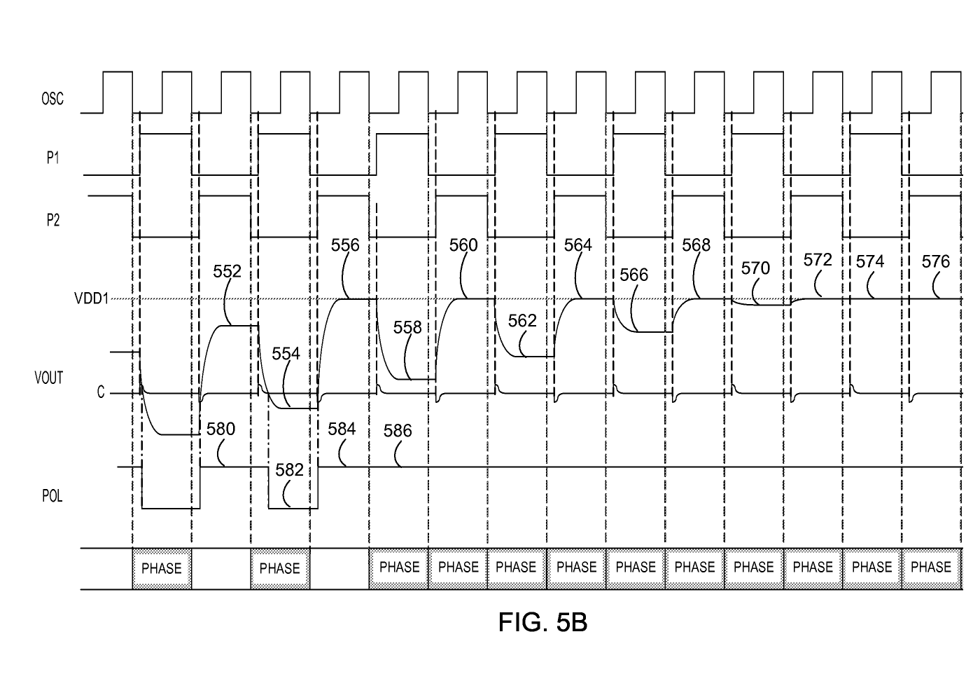

Touch sensor 204 is configured to detect changes in the capacitance of the scanned one of the sense capacitors 202-1, 202-2, . . . , 202-n at any given moment, as indicated by the signal 205 output from multiplexer 203. As will be explained in more detail with reference to FIGS. 4A through 5B, in one embodiment, touch sensor 204 is a CDC that detects the change in capacitance of the scanned one of the sense capacitors 202-1, 202-2, . . . , 202-n at any given moment in the form of binary data that changes from “0” to “1” when a user touches one of the keys corresponding to the scanned sense capacitor 202-1, 202-2, . . . , 202-n thereby causing change in the capacitance of the sense capacitor scanned sense capacitor 202-1, 202-2, . . . , or 202-n. For example, when the user touches key 1 (key 102 in FIG. 1), the capacitance of the corresponding sense capacitor 202-1 changes. When sense capacitor 202-1 is scanned under control of the sensor number signal 220, multiplexer 203 outputs signal 205 that reflects the change in capacitance of the corresponding sense capacitor 202-1. Such change in the capacitance is detected by touch sensor 204 as a change in the output bit stream 207 from “0” to “1” with the bit stream 207 being continuously “1” for a certain period during which the corresponding key is touched.

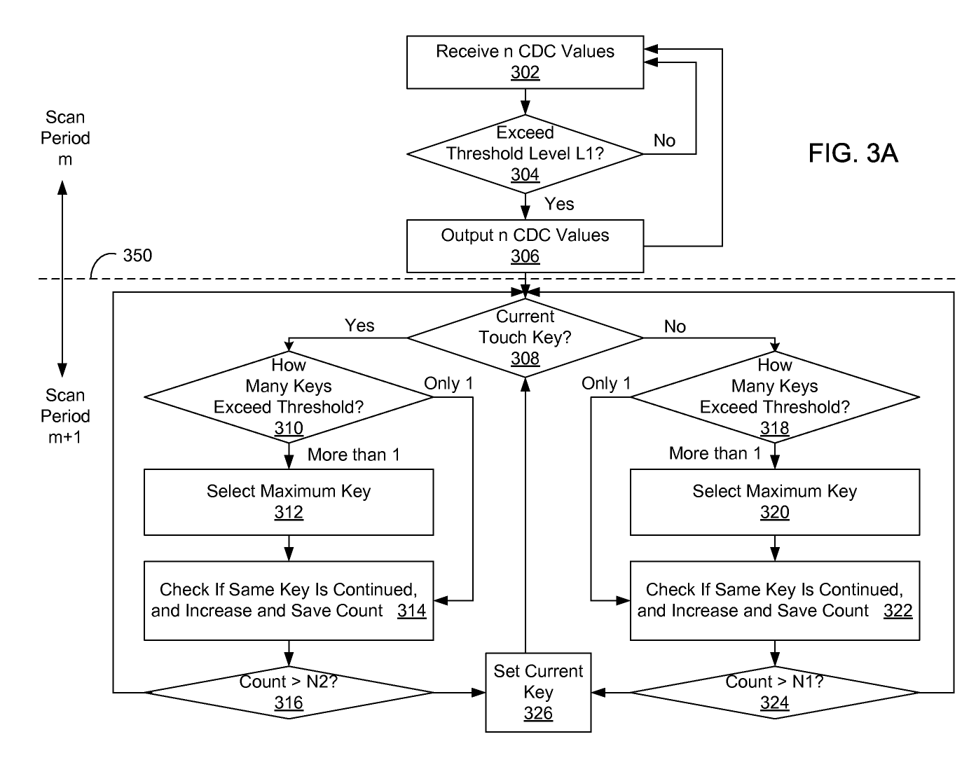

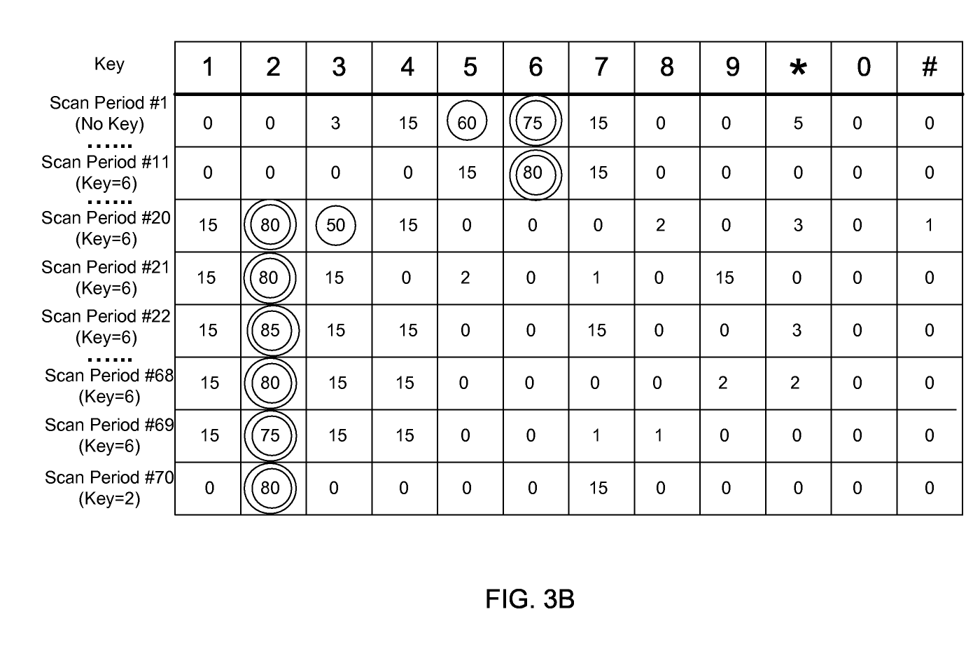

Such period during which the corresponding key is touched is also an indication of the “intensity” of the user's touch on the corresponding key. The period during which the binary signal 207 is continuously “1” is dependent upon how long the corresponding key 102 was touched (also corresponding to the intensity of the user's touch on the corresponding key 102), and can be measured in terms of the number of clock cycles of a clock signal (not shown herein) used in the circuitry of touch sensor 204 during which the change in the capacitance of the corresponding sense capacitor 202-1 is present and detected as the continuous bit stream of “1.” The number of continuous “1”s in binary data 207 can be counted by counter 208 in compare and decision logic 206 to determine how long the corresponding key 102 was touched by the user. As will be explained in further detail below, compare and decision logic 206 and control logic 212 also include other logic circuitry to implement the method of determining a user's touch according to the methods illustrated in FIGS. 3A and 3B. The compare and decision logic 206 and control logic 212 may be implemented as hard-wired logic circuitry or a small general purpose microprocessor with microcode for implementing the methods as illustrated in FIGS. 3A and 3B. Also, control and status registers 114 are memory devices storing a variety of threshold values and detected values for implementing the method of determining a user's touch according to the methods illustrated in FIGS. 3A and 3B. Control and status registers 114 may be flip flops and/or SRAMs or any other type of memory in one embodiment.

FIG. 3A illustrates a method for determining a user's touch on keys of a touch sensitive input device, according to one embodiment of the present invention. The method of FIG. 3A will be explained with further reference to FIG. 2. Referring to both FIG. 3A and FIG. 2, in step 302 compare and decision logic 206 receives n number of CDC values 207 during scan period m. This is made possible by the scanned sensor number signal 220 causing multiplexer 203 to rotate through the sense capacitors values 201-1, 201-2, . . . , 201-n during one scan period m, which is sensed by touch sensor 204 and output to counter 208. Counter 208 counts the number of times the CDC output signal 207 is continuously “1” with a continuous bit stream of “. . . 111111 . . . ” for each of the sense capacitors 202-1, 202-2, . . . , 202-n. As will be explained in more detail below, compare and decision logic 206 then determines in step 304 whether any of the counts of the counter 208 corresponding to the sense capacitors 202-1, 202-2, . . . , 202-n exceeds a predetermined threshold level (L1). If none of the counts of the counter 208 corresponding to the sense capacitors 202-1, 202-2, . . . , 202-n exceed a predetermined threshold level (L1), that means none of the touches on the corresponding key is a meaningful touch or that there was no touch at all on any of the corresponding keys, and the process returns to step 302 to receive the next set of n CDC values in the next scan period. If one or more of the counts of the counter 208 corresponding to the sense capacitors 202-1, 202-2, . . . , 202-n exceed the predetermined threshold level (L1) in step 304, that means one or more of the touches on the corresponding key are meaningful touches requiring further processing. Thus, in step 306 compare and decision logic outputs 306 the counts of counter corresponding to the n number of CDC values 207 corresponding to each of the sense capacitors 202-1, 202-2, . . . , 202-n to control logic 212 as signal 211. The threshold level (L1) used by compare and decision logic 206 in step 304 is programmable and may be stored in control and status registers 214 for retrieval 216 by compare and decision logic 206. The appropriate value for the threshold level (L1) may be determined empirically, so that meaningful touches are detected but accidental, meaningless touches are discarded.

The next steps 308 through 326 are performed in the subsequent scan period m+1, as shown with the dividing line 350. In the next scan period m+1, control logic 212 receives the n number of CDC values output from compare and decision logic 206 and in step 308 determines whether there is a currently set touch key. If there is a currently set touch key, then steps 310, 312, 314, 316, and 326 are performed, while if there is no currently set touch key then steps 318, 320, 322, 324, and 326 are performed.

Control logic 212 maintains and stores a data structure (key number, length_count, and repetition_count) in the control and status register 214 for each key of the touch sensitive input device 100 over a plurality of scan periods. “Key number” identifies the key of the touch sensitive input device 100 (1, 2, . . . , 9, *, 0, #). “Length_count” is the counter value of counter 208 as determined in step 302, indicating how long the corresponding key was touched during one scan period, and may be counted in terms of the number of clock cycles of the system clock used in the compare and decision logic 206. “Repetition_count” is a counter value tracked by counter 210 (FIG. 2), and indicates the total number of times the length_count of the counter 208 exceeded the threshold level in step 302 continuously in successive scan periods without interruption. Repetition_count may be counted in terms of the number of scan periods. Such data structure may be stored in the control and status register 214 for each key, for multiple scan periods (e.g., 8 scan periods), to maintain a history of the user's recent touches. For example, if there are 12 keys in the touch sensitive input device and the data structure is maintained for 8 scan periods, then there would be 96 records of such data structure stored in control and status register 214.

If there is no currently set touch key in step 308, control logic 212 determines in step 318 how many of the keys have counter 208 values (length_count) that exceed the threshold level (L1). If there is only 1 key that has a counter 208 value (length_count) that exceeds the threshold level (L1), this means only 1 key was touched for longer than the threshold period and the process proceeds directly to step 322 with that selected key. If there are more than 1 keys that have counter 208 values (length_count) that exceed the threshold level (L1), then in step 320 control logic 212 selects the key with the maximum counter value (maximum length_count), i.e., the key that was touched for the longest period.

Control logic 212 checks in step 322 whether the selected key is the same as the key selected in the previous scan period, and if the same key is selected continuously from the previous scan period, in step 322 repetition_count corresponding to that same key is increased. If the selected key is not the same key continued from the previous scan period but a new key, then in step 322 a new repetition_count is established for that selected key (starting at count 1) and the repetition_count corresponding to all other keys are reset to start from zero again. Control logic 212 also saves 322 the data structure (key number, length_count, and repetition_count) obtained in the current scan period in the control and status registers 114. Then, control logic 212 determines in step 324 whether repetition_count for the continuously selected key is greater than a threshold N1. The threshold N1 may be set empirically, so that it detects a meaningful touch by the user that lasts continuously for longer than a certain period (e.g., 10 scan periods) but discards accidental touches by the user that does not last long enough. Threshold level L1 may be stored in control and status registers 214. If repetition_count is greater than threshold N1 in step 324, the selected key is set as the current key in step 326 by control logic 212 and the process returns to step 308 to process the CDC values received in the subsequent scan period. In setting the currently set key in step 326, control logic 212 also stores the current set key in control and status register 114. However, if repetition_count is not greater than threshold N1 in step 324, then the process returns to step 308 without setting the current key, to process the CDC values received in the subsequent scan period.

Referring back to step 308, if there is a currently set touch key in step 308, that means another key was touched long enough to be set as the currently set key previously in step 326. In this case, control logic 212 determines in step 310 how many of the keys have counter 208 values (length_count) that exceed the threshold level (L1). If there is only 1 key that has a counter 208 value (length_count) that exceeds the threshold level (L1), this means only 1 key was touched for longer than the threshold period and the process proceeds directly to step 314 with that selected key. If there are more than 1 keys that have counter 208 values (length_count) that exceed the threshold level (L1), then in step 312 control logic 212 selects the key with the maximum counter value (maximum length_count), i.e., the key that was touched for the longest period.

Control logic 212 checks in step 314 whether the selected key is the same as the key selected in the previous scan period. In step 314, if the same key is selected continuously from the previous scan period, the repetition_count corresponding to that same key is increased. If the selected key is not the same key continued from the previous scan period but a new key, then in step 314 a new repetition_count is established for that selected key (starting at count 1) and the repetition_count corresponding to all other keys are reset to start from zero again. In step 314, control logic 212 also saves the data structure (key number, length_count, and repetition_count) obtained in the current scan period in the control and status registers 1 14. Then, control logic 212 determines in step 316 whether repetition_count for the continuously selected key is greater than a threshold N2. The threshold N2 may be set empirically, so that it detects a meaningful touch by the user that lasts continuously for longer than a certain period (e.g., 50 scan periods) but discards accidental touches by the user that does not last long enough to indicate a clear change in the touched key. Threshold level N2 may be stored in control and status registers 214. In one embodiment, threshold N2 in step 316 is greater than the threshold N1 in step 324, so that a longer period of user touch on the keys is required to change a currently set key than to initially set a currently set key. However, in other embodiments, threshold N1 may be same as threshold N2. Threshold level N2 may be stored in control and status registers 214. If repetition_count is greater than threshold N2 in step 316, the selected key is set in step 326 as the current key by control logic 212 and the process returns to step 308 to process the CDC values received in the subsequent scan period. This means the initial key set through steps 318, 320, 322, 324, 326 is replaced by the new key set through steps 310, 312, 314, 316, 326. Note that the new key replaces the initial key to become the new currently set key, even if the initial key still has maintains a CDC value exceeding the threshold level L1 indicating a valid touch on the initial key, if the new key has the maximum CDC value (length_count) continuously for longer than a predetermined period of time (N2). In setting the currently set key in step 326, control logic 212 also stores the current set key in control and status register 114. However, if repetition_count is not greater than threshold N2 in step 316, then the process returns directly to step 308 without changing the currently set key, to process the CDC values received in the subsequent scan period.

FIG. 3B illustrates an example of how the user's touch on keys of a touch sensitive input device is determined by the method of FIG. 3A according to one embodiment of the present invention. FIG. 3B shows 12 keys (1, 2, 3, . . . , 9, *, 0, #) and the length_count corresponding to each of the keys over a plurality of scan periods (scan period #1 through scan period #60).

Referring to FIG. 3B together with FIG. 3A, in scan period #1, all keys have length_counts of less than 30 (measured in number of clock cycles in one embodiment), except keys 5 and 6 that have length_counts of 60 and 75, respectively. This may mean that a user's touch overlapped over key 5 and key 6, with key 5 being touched for 60 clock cycles and key 6 being touched for 75 clock cycles while other keys were not touched. If the threshold length_count level (L1 in FIG. 3A, step 304) is 30, key 5 and key 6 have length_count exceeding the threshold length_count level, as indicated with circles around the length_count for keys 5 and 6 in scan period #1. When the corresponding key is not touched, length_count may be zero or a non-zero value less than the threshold length_count level (L1 in FIG. 3A, step 304) and close to zero (e.g., 1, 2, 3, 5, 15, etc.) due to noise caused by power, temperature, humidity, etc. Since there is more than 1 key with length_count exceeding the threshold length_count level (FIG. 3A, step 318) in scan period #1, key 6 with the maximum length_count (75) is selected (FIG. 3A, step 320) as indicated by the two circles surrounding the length_count corresponding to key 6 in scan period #1. Since key 6 was not the selected key in the previous scan period, repetition_count corresponding to all the keys are reset and repetition_count corresponding to key 6 is increased to 1, indicating that key 6 was touched for 1 scan period (FIG. 3A, step 322). However, since repetition_count (1) for key 6 does not exceed threshold N1 (e.g., 10) (FIG. 3A, step 324), key 6 is not set as the currently touched key (i.e., there is no currently set key). Also, assume that key 6 continues to have the maximum length_count in the subsequent scan periods #2 through #10, bringing the repetition_count for key 6 to “10” through a similar process as explained above. Next, in scan period I1, key 6 has the maximum length_count again with length_count 80. At this time, the repetition_count for key 6 is increased to 11 (FIG. 3A, step 322), thereby exceeding the threshold N2 (e.g., 10) (FIG. 3A, step 324). As a result, control logic 212 sets key 6 as the currently touched key (FIG. 3A, step 326).

At a later time during scan period #20, keys 2 and 3 have length_counts 80 and 50 exceeding the threshold level 30 (FIG. 3A, step 304). Since there is a currently set touch key (key 6) (FIG. 3A, step 308), the process proceeds to steps 310, 312, 314, 316, 326 of FIG. 3A. Among key 2 and key 3, key 2 is selected as having the maximum length_count in scan period #20 (FIG. 3A, step 312). Since key 2 was not the selected key in the previous scan period #19, repetition_count corresponding to all the keys are reset and repetition_count corresponding to key 2 is increased to 1, indicating that key 2 was touched for 1 scan period (FIG. 3A, step 314). However, since repetition_count (1) for key 2 does not exceed threshold N2 (e.g., 50) (FIG. 3A, step 316), key 2 is not set as the currently touched key, i.e., the currently set touched key continues to be key 6 in scan period 20. Also, assume that key 2 continues to have the maximum length_count in the subsequent scan periods #21 through #69 (for example, length_count 80, 85, . . . , 80, 75 in scan periods #21, #22, . . . , #68, #69), bringing the repetition_count for key 2 to “50” through a similar process as explained above. The currently set touched key continues to be key 6 in scan periods #21 through scan period #69. Next, in scan period #70, key 2 has the maximum length_count again with length_count 80. At this time, repetition_count for key 2 is increased to 51 (FIG. 3A, step 314), thereby exceeding the threshold N2 (e.g., 50) (FIG. 3A, step 316). As a result, control logic 212 sets key 2 as the currently touched key in scan period #70 (FIG. 3A, step 326), replacing the initially set key 6.

The method for determining a user's touch according to the present invention has the advantage that both the intensity of the user's touch as indicated by the length_count for each key and the length of the user's touch as indicated by the repetition_count for each key are considered in determining whether a particular key was touched by a user and whether to change the determined touch key of the touch sensitive input device. Since the various thresholds N1, N2, L1 are programmable, the sensitivity of the method according to the present invention may be conveniently modified, providing flexibility to the touch sense controller. By using different threshold values N1, N2 for determining an initial touch key and a change of the touch key, respectively, the touch sense controller may more accurately detect the user's touch of the keys without necessarily changing the touch key due to accidental touches on another, unintended key.

FIG. 4A illustrates a capacitance to digital converter (CDC) circuit used with the touch sensor controller circuit of FIG. 2, according to one embodiment of the present invention. CDC 204 may be used as the touch sensor 204 in FIG. 2. In FIGS. 4A, 4B, and 4C, one sense capacitor 202 (Csensor) is shown as connected to the CDC 204 at node 205, which corresponds to node 205 in FIG. 2, through N-type MOSFET (Metal Oxide Semiconductor Field Effect Transistor) 430. The sense capacitor 202 may be any one of sense capacitors 202-1, 202-2, . . . , 202-n. The multiplexer 203 is omitted in FIG. 4A for simplicity of illustration, and the example of FIG. 4A illustrates the situation where the multiplexer 203 connects one of the sense capacitors 202-1, 202-2, . . . , 202-n (FIG. 2) to the CDC 204 under control of the scanned sensor number 220. FIGS. 4A, 4B, and 4C additionally show the NMOS 430 that protects the CDC 204 from high voltages.

Referring to FIG. 4A, CDC circuit 204 includes reference capacitor C_{ref}, switches 410, 404, 406, 402, amplifiers AMP1, AMP2, capacitor Cᵢₙₜ, an inverter 408, and a D-type flip flop 400. N-type MOSFET 430 is connected in series with the CDC circuit 204 at node B between the two switches 402, 406 and the sense capacitor Cₛₑₙₛₒᵣ. The sense capacitor Cₛₑₙₛₒᵣ is connected in series with the NMOS 430, between NMOS 430 and ground. Switch 402 is connected between node B and ground. Switch 406 is connected between nodes B and C. Switch 404 is connected between nodes A and C. Switch 410 is connected in parallel with the reference capacitor C_{ref}, between voltage VH and node A. Amplifier AMP1 receives the voltage at node C at its negative input terminal and a DC voltage VM that is lower than the DC voltage VH at its positive voltage terminal. Amplifier AMP1 and capacitor Cᵢₙₜ form an integrator integrating the voltage at node C and outputs an integrated output voltage VOUT. Amplifier AMP2 compares VOUT at its positive input terminal to the voltage at node C at its negative input terminal, and outputs POL. POL is the data input to the D type flip flop 400. The D type flip flop 400 is operated by a clock signal that is an inverted from the oscillator signal OSC by the inverter 408. The non-inverted output of the D type flip flop 400 is the PHASE signal and the inverted output of the D type flip flop 400 is the PHASEB signal. The PHASE signal corresponds to signal 207 output from touch sensor 204 (see FIG. 2), and the number of pulses in the PHASE signal is counted by counter 208 to determine length_count for the sense capacitor 202 corresponding to the scanned touch key of interest.

A non-overlapping 2-phase clock signal (P1 or P2) formed by clock signals P1 and P2 is applied to the gate of NMOS 430 to control the turning on and off of the NMOS 430. As will be explained in more detail below, the clock signals P1 and P2 are non-overlapping in the sense that they are not at logic high at the same time. In other words, if the clock signal P1 is at logic high, the clock signal P2 is at logic low. If the clock signal P2 is at logic high, the clock signal P1 is at logic low. Switches 402, 404 are turned on and off according to the clock signal P1, while switches 406, 410 are turned on and off according to the clock signal P2.

FIG. 4B illustrates the operation of the CDC circuit of FIG. 4A in one phase, according to one embodiment of the present invention. The example of FIG. 4B illustrates the situation where the clock signal P1 is at logic high and the clock signal P2 is at logic low. Accordingly, switches 402, 404 are turned on and switches 406, 410 are turned off. NMOS 430 is turned on due to clock signal P1. Thus, the charges stored in the sense capacitor Cₛₑₙₛₒᵣ are discharged 414 to ground through the NMOS 430 and the switch 402, thereby resetting the sense capacitor Cₛₑₙₛₒᵣ. Since switch 406 is turned off, the sense capacitor Cₛₑₙₛₒᵣ is disconnected from node C. In contrast, the reference capacitor C_{ref} is connected to node C through the switch 404. Positive DC voltage VH charges 412 capacitor Cᵢₙₜ connected to the negative input of the amplifier AMP1, whose voltage is integrated to generate VOUT. Thus, VOUT is negative and POL is also negative, resulting in the PHASE signal of “0” and PHASEB signal of “1” sampled at the clock frequency of the D-type flip flop 400.

FIG. 4C illustrates the operation of the CDC circuitry of FIG. 4A in another phase, according to one embodiment of the present invention. The example of FIG. 4C illustrates the situation where the clock signal P1 is at logic low and the clock signal P2 is at logic high. Accordingly, switches 402, 404 are turned off and switches 406, 410 are turned on. NMOS 430 is turned on due to clock signal P2. In this situation, the sense capacitor Cₛₑₙₛₒᵣ is connected to node C through NMOS 430 and the switch 406. Thus, the charges from the integration capacitor Cᵢₙₜ are stored 416 in the sense capacitor Cₛₑₙₛₒᵣ through the NMOS 430 and the switch 406. Thus, VOUT is positive and POL is also positive, resulting in the PHASE signal of “1” and PHASEB signal of “0” sampled at the clock frequency of the D-type flip flop 400. Since switch 404 is turned off, the reference capacitor C_{ref} is disconnected from node C and is discharged (reset) 418.

FIG. 5A is a timing diagram illustrating the operation of the CDC circuitry of FIG. 4A, when the capacitance on the sense capacitor 202 is not disturbed by a touch on the corresponding key in the touch sensitive input device. FIG. 5A is explained in conjunction with FIG. 4A. As shown in FIG. 5A, the oscillator signal OSC provides the inverted clock signal for the D-type flip flop 400. OSC may also be the system clock used by counter 208 and the compare and decision logic 206. The PHASE signals are sampled 502, 504, . . . , 514 by the D type flip flop 400 at the falling edge of the OSC signal, due to the inverter 408. Signals P1 and P2 together form a non-overlapping 2-phase clock signal, where P1 is at logic high while P2 is at logic low, and P2 is at logic high while P1 is at logic low. Break-before-make intervals 520, 522 are built into the clock signals P1, P2 so that clock signals P1, P2 are not at logic high at the same time.

The voltage at node A transitions from VH to VM when P1 transitions to logic high, and transitions from VM to VH when P2 transitions to logic high. VH is a DC voltage applied to one end of the reference capacitor C_{ref}, and VM is another DC voltage lower than VH and applied to the positive input of the amplifier AMP1. The voltage at node B transitions from VM to ground when P1 transitions to logic high, and transitions from ground to VM when P2 transitions to logic high. This is because the voltage at node C is approximately the same as VM with ripples 524 occurring when P1 transitions to logic high and ripples 526 occurring when P2 transitions to logic high. That is, the DC components of the voltage at node C are the same as the voltage VM.

As explained above, the output VOUT of the integrator (AMP1, Cᵢₙₜ) transitions to logic low when P1 transitions to logic high, and transitions to logic high when P2 transitions to logic high. In this manner, VOUT alternates between low voltage and high voltage when the capacitance on the sense capacitor Cₛₑₙₛₒᵣ 202 is not disturbed by a touch on the corresponding key. Likewise, the output POL of the amplifier AMP2 transitions to logic low when P1 transitions to logic high, and transitions to logic high when P2 transitions to logic high. In this manner, POL alternates between logic low and logic high when the capacitance on the sense capacitor Cₛₑₙₛₒᵣ 202 is not disturbed by a touch on the corresponding key. As a result, PHASE outputs a data stream 502, 504, 506, 508, 510, 512, 514 of “1010101 . . . ” when the capacitance on the sense capacitor Cₛₑₙₛₒᵣ is not disturbed by a touch on the corresponding key.

FIG. 5B is a timing diagram illustrating the operation of the CDC circuitry of FIG. 4A, when the capacitance on the sense capacitor 202 is disturbed by a touch on the corresponding key. The timing diagram of FIG. 5B shows the same signals as those shown in FIG. 5A, except that the voltages at nodes A, B, and C are not shown for simplicity of illustration. When the capacitance on the sense capacitor Cₛₑₙₛₒᵣ 202 is disturbed by a touch on the corresponding touch key, VOUT starts to increase in each cycle 552, 554, 556, 558, 560, 562, 564, 566, 568, 570 and maintains the high voltage 572, 574, 576 saturated at the supply voltage VDD1 of the CDC circuit 204. POL alternates between logic high 580 and logic low 582 as explained previously with reference to FIG. 5B until the point where VOUT does not fall below the voltage at node C (see 558). At that point, the POL also does not return to logic low (i.e., maintains logic high (see 586)). As a result, PHASE outputs a continuous data stream of 1's soon after the capacitance on the sense capacitor Cₛₑₙₛₒᵣ is disturbed by a touch on the touch screen. The PHASE data stream shown in FIG.5B would be “10101111111111 . . . ” The number of times the PHASE data stream 208 is continuously “1” is counted by counter 208 (FIG. 2) to determine length-count of the sense capacitor 202 for the corresponding key. When the touch is removed, the PHASE signal will revert to an alternating data stream of “1010101 . . . ” as shown in FIG. 5A, although not shown in FIG. 5B.

Upon reading this disclosure, those of skill in the art will appreciate still additional alternative designs for a method for determining user's touch on keys of a touch sensitive input device and a touch sense controller for implementing such method. Thus, while particular embodiments and applications of the present invention have been illustrated and described, it is to be understood that the invention is not limited to the precise construction and components disclosed herein and that various modifications, changes and variations which will be apparent to those skilled in the art may be made in the arrangement, operation and details of the method and apparatus of the present invention disclosed herein without departing from the spirit and scope of the invention as defined in the appended claims.

What is claimed is:

1. A method of determining a touched key of a touch sensitive input device including a plurality of touch sensitive keys, the method comprising:
receiving first signals indicative of touch on one or more of the touch sensitive keys;
selecting a first key as a user-selected key, if the first key is associated with maximum signal among the first signals continuously for longer than a first predetermined period;
receiving second signals indicative of touch on one or more of the touch sensitive keys; and
changing the user-selected key from the first key to a second key, if the second key is associated with the maximum signal among the second signals continuously for longer than a second predetermined period.

2. The method of claim 1, wherein the first key is maintained as the user-selected key until the user-selected key is changed to the second key.

3. The method of claim 1, further comprising:
determining whether the first signals indicate a valid touch on at least one of the touch sensitive keys; and
determining whether the second signals indicate a valid touch on at least one of the touch sensitive keys.

4. The method of claim 3, wherein the user-selected key is changed from the first key to the second key, even if the second signals indicate a valid touch on the first key.

5. The method of claim 3, wherein:
determining whether the first signals indicate a valid touch on at least one of the touch sensitive keys comprises determining whether the first signals indicate a period of touch on said at least one of the touch sensitive keys for longer than a predetermined threshold; and
determining whether the second signals indicate a valid touch on at least one of the touch sensitive keys comprises determining whether the second signals indicate a period of touch on said at least one of the touch sensitive keys for longer than the predetermined threshold.

6. The method of claim 5, wherein the maximum signal among the first signals indicates a longest period of touch on the first key and the maximum signal among the second signals indicates the longest time period of touch on the second key.

7. The method of claim 1, wherein the first signals correspond to touches on the touch sensitive keys over a first plurality of scan periods, and the second signals correspond to touches on the touch sensitive keys over a second plurality of scan periods subsequent to the first plurality of scan periods.

8. The method of claim 1, wherein the second predetermined period is longer than the first predetermined period.

9. The method of claim 1, wherein the first predetermined period and the second predetermined period are programmable.

10. The method of claim 1, wherein the touch sensitive input device is a touch sensitive keypad used with a mobile telephone.

11. A touch sensitive input device comprising:
a plurality of touch sensitive keys;
a touch sensor coupled to one or more of the touch sensitive keys and configured to generate touch sensor signals indicative of touch on one or more of the touch sensitive keys; and
touch control logic coupled to the touch sensor to receive the touch sensor signals, the touch controller logic configured to:
select a first key as a user-selected key, if the first key is associated with maximum signal among first touch sensor signals continuously for longer than a first predetermined period; and
change the user-selected key from the first key to a second key, if the second key is associated with the maximum signal among second touch sensor signals continuously for longer than a second predetermined period, the first touch sensor signals corresponding to touches on one or more of the touch sensitive keys over a first plurality of scan periods and the second touch sensor signals corresponding to touches on one or more of the touch sensitive keys over a second plurality of scan periods subsequent to the first plurality of scan periods.

12. The touch sensitive input device of claim 11, wherein the touch control logic is configured to maintain the first key as the user-selected key until the user-selected key is changed to the second key.

13. The touch sensitive input device of claim 11, wherein the touch control logic is further configured to:
determine whether the first touch sensor signals indicate a valid touch on at least one of the touch sensitive keys; and
determine whether the second touch sensor signals indicate a valid touch on at least one of the touch sensitive keys.

14. The touch sensitive input device of claim 13, wherein the touch control logic is configured to change the user-selected key from the first key to the second key, even if the second touch sensor signals indicate a valid touch on the first key.

15. The touch sensitive input device of claim 13, wherein:
the touch control logic is configured to determine whether the first touch sensor signals indicate a valid touch on at least one of the touch sensitive keys by determining whether the first touch sensor signals indicate a period of touch on said at least one of the touch sensitive keys for longer than a predetermined threshold; and
the touch control logic is configured to determine whether the second touch sensor signals indicate a valid touch on at least one of the touch sensitive keys by determining whether the second touch sensor signals indicate a time period of touch on said at least one of the touch sensitive keys for longer than the predetermined threshold.

16. The touch sensitive input device of claim 15, wherein the maximum signal among the first touch sensor signals indicates a longest period of touch on the first key and the maximum signal among the second touch sensor signals indicates the longest period of touch on the second key.

17. The touch sensitive input device of claim 11, wherein the touch sensor is a capacitance-to-digital convertoer coupled to one or more sense capacitors corresponding to said one or more of the touch sensitive keys.

18. The touch sensitive input device of claim 11, wherein the second predetermined period is longer than the first predetermined period.

19. The touch sensitive input device of claim 11, further comprising a memory device storing the first predetermined period and the second predetermined period, said first predetermined period and the second predetermined period being programmable.

20. The touch sensitive input device of claim 11, wherein the touch sensitive input device is a touch sensitive keypad used with a mobile telephone.
